(19) United States
(12) Patent Application Publication
(10) Pub. No.: US 2026/0255030 A1
(43) Pub. Date: Aug. 27, 2026

(54) SYSTEM FOR THE PRODUCTION OF A MOVIE USING AN APPLICATION

(71) Applicant: Roger Janik, conroe, TX (US)

(72) Inventor: Roger Janik, conroe, TX (US)

(21) Appl. No.: 19/423,084

(22) Filed: Dec. 17, 2025

Related U.S. Application Data
(63) Continuation-in-part of application No. 18/760,096, filed on Jul. 1, 2024, now abandoned.

(51) Int. Cl. H04N 21/854; H04N 21/81

(52) U.S. Cl. CPC H04N 21/854; H04N 21/816

(57) ABSTRACT

A computer-implemented system and method for producing a multi-scene digital video composition through sequential user contributions is disclosed. A processing system enforces structured scene creation by assigning each scene to a defined position within a predetermined sequence and restricting continuation to a single designated contributor or a publicly accessible pool within a defined time constraint. Each submitted scene is validated and permanently locked from modification upon acceptance. The system automatically controls progression between contributors, enforces deadlines, and prevents unauthorized editing or reordering of scenes. Accepted scenes are assembled by the system into a final video composition in a fixed sequence without user intervention. If continuation conditions are not satisfied within the defined time, the system automatically finalizes or suspends the composition based on predefined criteria and publishes the resulting content to a feed.

### CROSS-REFERENCE TO RELATED APPLICATIONS

This application claims the benefit of U.S. patent application Ser. No. 18/760,096 filed Jul. 1, 2024, which claims priority to U.S. Provisional Patent Application No. 63/514,468 filed Jul. 19, 2023. Both applications are incorporated by reference herein in their entirety. This application is a continuation-in-part and additionally includes new matter directed to sequential tag-based collaborative movie production, automated fallback contribution handling, and system-initiated completion logic.

### COPYRIGHT STATEMENT

A portion of the disclosure of this patent document contains material subject to copyright protection. The copyright owner has no objection to the facsimile reproduction of this patent document or the patent disclosure as it appears in the United States Patent and Trademark Office files or records, but otherwise reserves all copyright rights whatsoever.

### TRADEMARK DISCLAIMER

Applicant makes no claim to any trademarks referenced herein.

### BACKGROUND OF THE INVENTION

### Field of the Invention

The present invention relates generally to digital film production and, more particularly, to systems and methods for producing multi-scene movies using software operating on personal mobile devices or computing systems in a distributed network environment.

### Description of Related Art

Traditional short-film production requires extensive pre-production planning, casting, location scouting, lighting preparation, and specialized camera equipment. These requirements significantly increase cost and complexity.

A typical short film may cost between hundreds and thousands of dollars per finished minute. These constraints arise in part from fragmented production pipelines, manual post-production workflows, and the inability of conventional digital systems to coordinate asynchronous scene capture and automated assembly across distributed contributors.

Existing digital video-production applications are primarily designed for single-user editing workflows or sequential clip manipulation and do not provide system-level orchestration for coordinating multiple remote contributors, enforcing submission constraints, validating independently recorded scene segments, or automatically assembling such segments into a structured multi-scene narrative. As a result, conventional systems require substantial manual intervention, external editing tools, or centralized post-production processes to complete a finished motion picture.

There is a need for a unified production system capable of programmatically coordinating multi-scene motion-picture creation across geographically distributed contributors, including automated role assignment, submission validation, deadline enforcement, and system-controlled assembly of independently recorded scenes into a cohesive digital motion picture without requiring manual editing or external post-production software.

By contrast with conventional mobile video applications that operate on isolated clips or user-directed timelines, the present system introduces automated orchestration logic that governs contributor participation, scene sequencing, validation gating, and publication conditions at the system level. Such functionality is not provided by existing social-video, editing, or clip-sharing platforms.

Unlike prior systems that merely collect user-submitted clips for later compilation, the present system enforces production-state gating at the system level, such that scene submission, validation, deadline expiration, and publication transitions are executed automatically by the processing device according to stored execution rules. Contributors cannot independently alter sequencing, bypass validation, or manually trigger assembly, thereby distinguishing the system from prior art that relies on user-driven editing timelines or post-production intervention.

Conventional digital video systems lack a unified execution model for coordinating asynchronous scene capture, enforcing contributor-specific submission constraints, validating independently generated media segments, and deterministically triggering automated assembly without manual intervention.

The disclosed system operates as a state-driven execution framework in which media-processing operations are conditionally invoked based on stored workflow states, validation flags, and deadline expiration events. Scene submissions are not processed as free-form media assets, but as state-bound data objects whose progression through capture, validation, assembly, and publication states is governed by machine-enforced execution rules. This architecture reduces processing contention, eliminates user-controlled branching, and enables deterministic media assembly on resource-constrained mobile and cloud computing environments.

### SUMMARY OF THE INVENTION

### Mobile Video Creation and Collaboration

The invention provides a technical improvement to distributed media-processing systems by introducing a system-controlled orchestration layer that governs contributor participation, enforces submission constraints, validates independently recorded scene segments, and automatically transitions production states to invoke a deterministic assembly engine without user-directed editing actions. This architecture reduces manual processing states, minimizes coordination overhead, and enables automated completion of multi-scene digital motion pictures across distributed computing environments. In certain embodiments, the system is structured around multiple functional modes, including Direct, Act, Compete, Engage, and Movie-Tag.

### Direct

The Direct feature guides a director through structured film creation. Directors may build scene layouts, generate scripts using templates or artificial intelligence, cast actors, and pre-select post-production elements including transitions, filters, background images, titles, hashtags, genre designations, and audio.

### Act

The Act feature supports open-call casting. Any user may browse available scenes, claim a role, review script lines or continuation prompts, record a performance using a personal mobile device, and upload the scene asynchronously for validation and possible inclusion in a movie.

### Compete

The Compete feature supports time-bound acting challenges and competitions. Users may receive randomized prompts or assigned scenes, record performances, and vote on completed movies or actors within a judging window.

### Engage

The Engage feature supports derivative creativity. Directors may produce a Director's Cut. Users may create a Fan Twist, Tag Twist, prequel, sequel, or cloned version of an existing movie subject to system-defined permissions and mode-specific limits.

### AI Assistance and Automated Post-Production

Artificial intelligence tools may generate scripts, prompts, creative suggestions, continuity cues, moderation classifications, or post-production recommendations based on stored templates, trained language models, machine-learning models, rule-based systems, hybrid inference engines, predefined rule sets, or combinations thereof.

### Cloning and Alternative Versions

A cloning feature allows directors or authorized users to duplicate an existing film structure and re-direct it with new actors, modified scenes, altered casting paths, revised scripts, or different post-production templates.

### Proprietary Assembly, Moderation, and Notification

The system includes proprietary algorithms for assembling independently recorded scenes into cohesive motion pictures.

The assembly engine automatically joins scenes in script order, contribution order, or other mode-specific order, applying timing corrections, transitions, stylistic effects, continuity normalization, and output rendering operations.

Completed movies are automatically or semi-automatically published to a public feed. Contributors may receive notifications, playback links, ranking updates, award notices, or monetization notices.

AI-based moderation may evaluate uploaded scenes for harmful, age-restricted, policy-violating, or quality-deficient content. The system may enforce differentiated rules based on age, role type, content category, or jurisdiction.

### Multi-Version Creativity

Directors may generate updated versions of their films as Director's Cuts.

Users may add a prequel or sequel scene to create a Fan Twist or Tag Twist, automatically stitched into the original or derivative output subject to system-defined permissions. A Fan Twist may refer to a derivative version created from an already published movie by appending or prepending one or more additional scenes without altering the underlying original assembled movie, whereas a Tag Twist may refer to a derivative version created under Movie-Tag-specific permissions and constraints.

### In-App Digital Economy

The system may integrate a digital currency known as tickets, trophies, points, credits, tokens, PopCoins, or other virtual consideration.

Tickets may be used to incentivize actors, purchase visibility boosts, extend participation windows, buy trophies, purchase digital gifts, compensate performers, unlock enhanced participation options, or access monetization features.

When tickets or gifts are applied to a film, a predefined percentage may be awarded to a director and another percentage may be divided among one or more cast members or contributors according to stored distribution rules.

### Global Collaboration

The system may use cloud-based services, moderation tools, and distributed infrastructure to support global filmmaking collaboration.

Movies may be completed in one hour or less, in twenty-four hours or less, or within another defined production window using automated workflows.

Contributors may require only a mobile device to participate.

Directors may cast globally, invite named users, open roles publicly for asynchronous claiming, or trigger tag-based contribution chains.

Automated stitching and post-processing reduce or eliminate the need for editing expertise.

### System Architecture Summary

The system includes components for presenting roles, accepting asynchronous recordings, applying deadlines, validating submissions, tracking workflow state, managing continuation logic, and assembling final movies.

Contributors may record scenes from any global location.

Post-production may include transitions, filters, color grading, title generation, soundtrack layering, background audio, subtitle insertion, watermarking, or other output refinements.

Completed films may be automatically or semi-automatically published and contributors notified.

### Tag-Based Filmmaking (High-Level Summary Only)

In some embodiments, the system includes a sequential tag-based workflow in which each contributor creates a scene and designates the next participant or opens the next scene to a public participation pool. The system enforces one or more deadlines, validates submissions, optionally applies fallback invitation logic, and may automatically complete or suspend the movie based on a minimum completed-scene threshold and other stored rules.

### Conclusion of Summary

The invention provides a comprehensive platform for collaborative filmmaking, automated assembly, creative enhancement, derivative storytelling, sequential contributor orchestration, and bounded execution of distributed media workflows.

### TECHNICAL DETAILS/HOW IT WORKS

The system is powered by software supporting Core Mode scene creation, scene submission, automated post-production, content moderation, and film assembly, as well as Movie-Tag Mode chain execution, continuation selection, fallback contribution handling, and system-initiated completion.

At the center is an assembly algorithm that programmatically joins independently recorded scenes according to director-defined, system-defined, or mode-specific structure.

Automated post-production applies selected template elements, filters, transitions, titles, genre metadata, hashtags, audio layers, and other finishing elements after required scenes are validated.

After assembly, the system automatically or semi-automatically publishes the film to the public feed and notifies contributors. As used herein, ‘semi-automatic publication’ refers to publication initiated by a user action, such as an authorized wrap-and-publish selection, while rendering, metadata generation, output encoding, feed posting, and contributor notification are executed by the system without manual editing or manual rendering intervention.

AI-based moderation may evaluate scenes for inappropriate content, mature classifications, policy compliance, quality compliance, or suitability for publication. Age-based restrictions may be enforced.

Directors or authorized contributors may generate Director's Cuts with modified scene selections, additional scenes, revised ordering, or stylistic changes subject to mode-specific constraints.

Fan Twists or Tag Twists allow a user to create a derivative version of an existing produced movie by adding one or more additional scenes at the beginning or end of the movie or by creating another system-permitted variation. In certain embodiments, a Fan Twist is a derivative extension available for a published movie under system-defined permissions, while a Tag Twist is a derivative extension limited to users who previously contributed to a Movie-Tag chain. Such twists may be created only after the original movie has been assembled and published, and may be restricted to prior contributors in certain modes.

Multiple versions of a film may therefore be created through automated processes.

Tickets act as virtual currency for rewards and incentives.

Directors or contributors may use tickets to attract actors, extend participation windows, encourage tagged users to accept a scene, or reward participation.

Gifted tickets may distribute a configured share to a director and another configured share evenly or proportionally across one or more cast members.

Tickets may be redeemed for digital gifts, trophies, enhancements, optional participation extensions, or real-currency cash-out through a linked virtual balance system, depending on system configuration.

This digital economy incentivizes participation.

The system may integrate algorithms, cloud infrastructure, moderation engines, automated post-production, continuation controls, and currency management.

### BRIEF DESCRIPTION OF DRAWINGS

Additional understanding may be gained from the drawings.

FIG. 1 illustrates an embodiment of a distributed movie-production system architecture including a cloud-based server environment, a media and metadata repository, user devices, and contributor participation paths for both director-driven and sequential contribution workflows.

FIG. 2 illustrates an embodiment of a functional architecture of a movie-production system including modular algorithms selectively enabled based on an active production mode.

FIG. 3 illustrates a core production workflow for creating a multi-scene movie using automated assembly.

FIG. 4 illustrates example graphical user interfaces for interacting with core features of a movie-production system.

FIG. 5 illustrates an embodiment of a system-managed invitation and contribution workflow in which initiation, invitations, scene submission, and optional subsequent movie initiation occur through system-coordinated processes.

FIG. 6 illustrates ticket-economy workflows including purchase, gifting, actor compensation, participation extensions, and visibility enhancement.

FIG. 7A illustrates an embodiment of a distributed multi-scene movie production method for a core director-driven mode.

FIG. 7B illustrates a tag-based sequential production method in which continuation, deadline enforcement, and conditional completion occur through system logic.

FIG. 8 illustrates an example Movie-Tag Mode workflow including scene creation, selection of a continuation method, subsequent scene submission, conditional continuation, pending-state transition, and system-initiated wrap-and-publish.

### DETAILED DESCRIPTION OF THE INVENTION (CIP—CORE MODE AND MOVIE-TAG MODE)

While various aspects and features of certain embodiments have been summarized above, the following detailed description provides exemplary embodiments in further detail to enable one skilled in the art to practice such embodiments. These examples are provided for illustrative purposes only and are not intended to limit the scope of the invention.

In the following description, numerous specific details are provided to facilitate understanding of the disclosed embodiments. It will be apparent, however, to those skilled in the art that other embodiments may be practiced without some or all of these specific details. Features described with respect to one embodiment may be incorporated into other embodiments unless explicitly stated otherwise. No single described feature is essential to every embodiment of the invention.

Throughout this application, the singular includes the plural unless expressly stated otherwise. The terms ‘and,’ ‘or,’ and ‘and/or’ encompass any and all combinations of the listed elements. Additionally, the terms ‘including,’ ‘includes,’ and similar language are non-exclusive unless otherwise indicated.

The terms ‘or’ and ‘and/or’ are inclusive and mean any of A, B, or C individually or in combination, unless a combination is inherently impossible. These interpretive principles apply throughout the specification and claims.

As the invention may take many forms, the present disclosure should be considered illustrative rather than limiting. The detailed embodiments described herein demonstrate principles of the invention but do not define its outer boundaries.

### System Overview (Mozaik Core Mode)

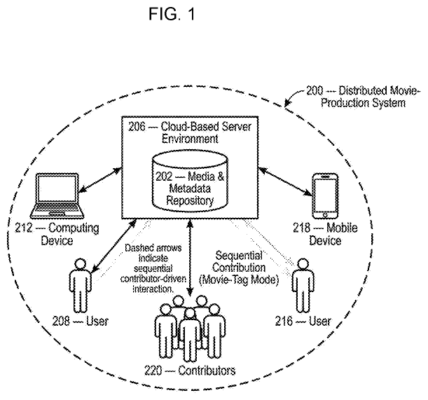

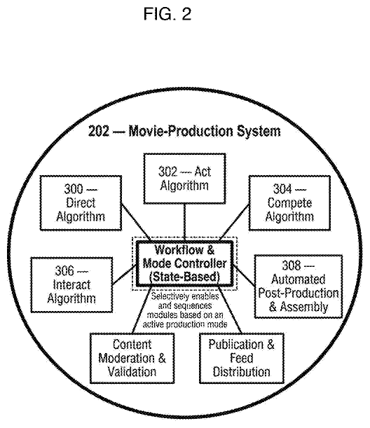

Referring to FIGS. 1-2, a functional system diagram 200 is shown. A distributed movie-production system 200 may include a cloud-based server environment 206 hosting a media and metadata repository 202, one or more computing devices 212, one or more mobile devices 218, one or more directors or users 208, 216, and one or more contributors 220. The system may further include a Direct algorithm 300 supporting directors in defining scene structure, casting rules, submission requirements, and post-production templates; an Act algorithm 302 enabling users to claim open roles and upload recorded scenes asynchronously; a Compete algorithm 304 supporting acting competitions; an Engage algorithm 306 enabling directors and users to generate derivatives in accordance with system-defined permissions; and an automated post-production and assembly algorithm 308 applying system-controlled finishing operations. A workflow and mode controller selectively enables or sequences the foregoing modules based on an active production mode and current workflow state.

In Core Mode embodiments, the system supports a distributed production workflow in which a director defines a multi-scene structure and remotely collects independently recorded scene submissions from multiple contributors. The system enforces duration constraints per scene and enforces a production window such that required scenes are submitted within a defined time period, after which the system assembles and publishes the movie using an automated assembly engine.

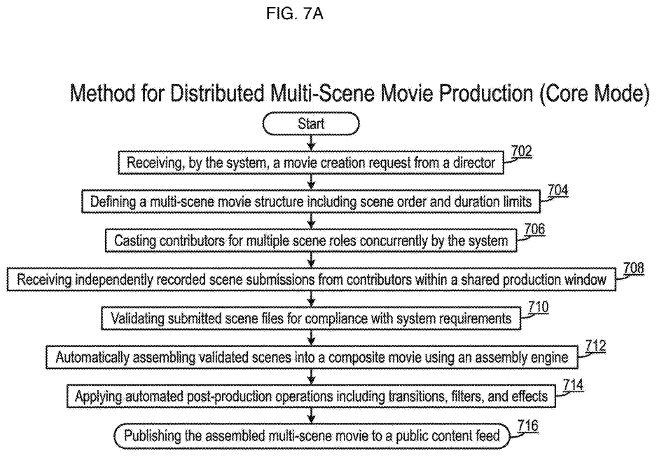

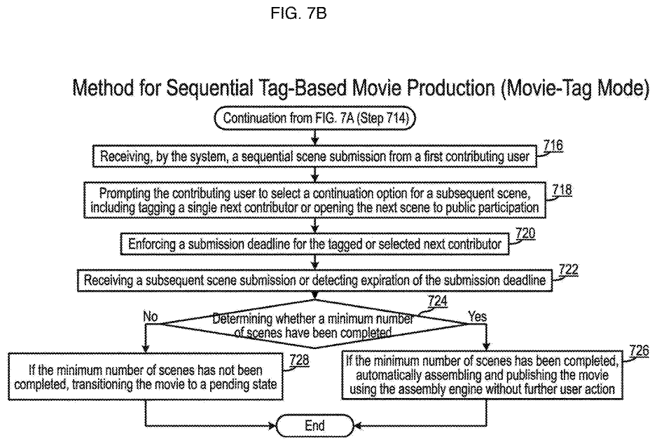

FIG. 7A further illustrates a core director-driven production workflow in which the system receives a movie-creation request, defines a multi-scene movie structure including scene order and duration limits, casts contributors for multiple scene roles, receives independently recorded scene submissions within a shared production window, validates the submitted scenes, assembles validated scenes using the assembly engine, applies automated post-production operations, and publishes the assembled multi-scene movie to a public content feed.

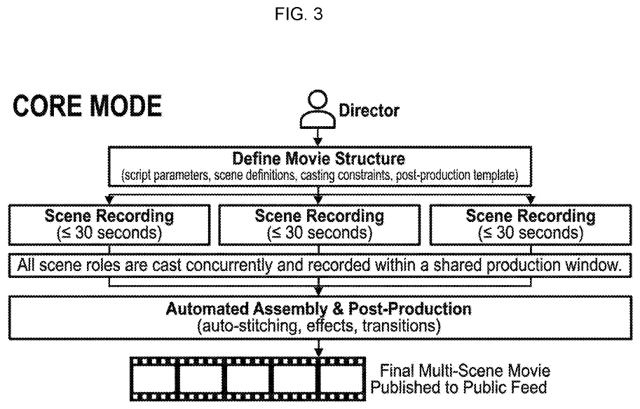

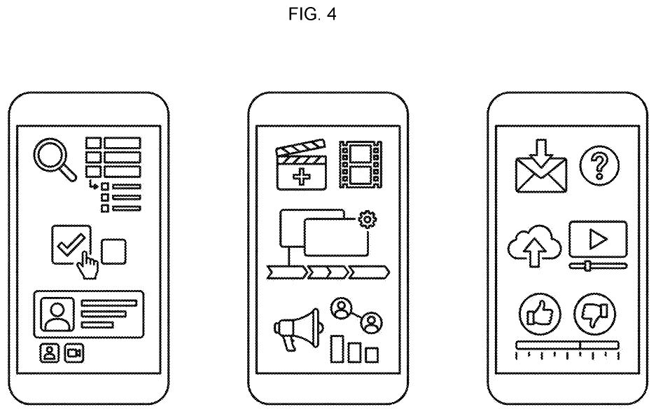

### Movie-Stitching and Production Workflow (FIGS. 3-4)

FIG. 3 illustrates an example Core Mode production method. At a first stage, a director defines a movie structure, including scene parameters, scene definitions, casting constraints, and a post-production template. Each scene may have a predefined maximum duration, such as thirty seconds. One or more actors may be assigned to each scene, and different actors may be assigned to different scenes according to a director-defined narrative structure. The system may cast contributors concurrently for multiple scene roles, receive recorded scenes within a shared production window, validate those scenes, automatically stitch the scenes together using a movie-stitching algorithm, and publish the completed multi-scene movie to a public feed or other distribution mechanism.

The movie-stitching algorithm programmatically integrates independently recorded scenes into a cohesive narrative according to the applicable scene order. In Core Mode, the order may correspond to a director-defined scene order. Automated post-production may apply background music, transitions, filters, background images, title cards, intro sequences, credit screens, or other effects selected in advance.

Unlike collaborative video-editing platforms that permit multiple users to modify a shared timeline or editing graph, the present system prohibits contributor-level manipulation of sequencing, transitions, or assembly logic. Scene order, inclusion, and processing may be determined exclusively by system-maintained metadata and execution rules, thereby preventing race conditions, conflicting edits, and non-deterministic output that arise in prior collaborative editing systems.

FIG. 4 depicts example graphical user interfaces rendered on a display device 400. Example interfaces include an Act interface 402, a Direct interface 404, a Compete interface 406, and optionally an Engage interface. The graphical layout illustrated in FIG. 4 is exemplary only; the underlying functions are independent of any particular interface arrangement.

The Act feature 402 enables open-call casting by allowing directors to publish available scene roles to the system. Any user may browse available roles, claim a role, record a corresponding scene using a personal mobile device, and submit the scene asynchronously for possible inclusion in the movie.

Display device 400 may also illustrate the Direct feature 404, which may provide a guided creation wizard. Directors may generate ideas using artificial intelligence tools, define a sequence of scenes, and pre-select post-production elements. These selections may form a template applied uniformly during automated editing and assembly.

The Direct-feature wizard may guide directors through structured steps such as defining a movie title, synopsis, character list, scene layout, scene-by-scene dialogue, role requirements, production deadlines, and post-production templates.

Directors may cast roles to specific actors, invite known users, or post open roles to an Act page. Actors claiming a role may receive script lines, instructions, prompts, or continuation context and may upload their recorded scenes asynchronously.

The Compete feature 406 may introduce daily or recurring competitions. Users may receive a randomized scene prompt curated by the system, reveal or unlock a scene assignment, record and submit their version, and vote on completed competition movies or actors.

Competition themes may include stylistic constraints, lighting prompts, camera-movement guidance, narrative context, character direction, prop limitations, or genre requirements.

Display device 400 may be implemented using smartphones, tablets, laptops, or desktop devices.

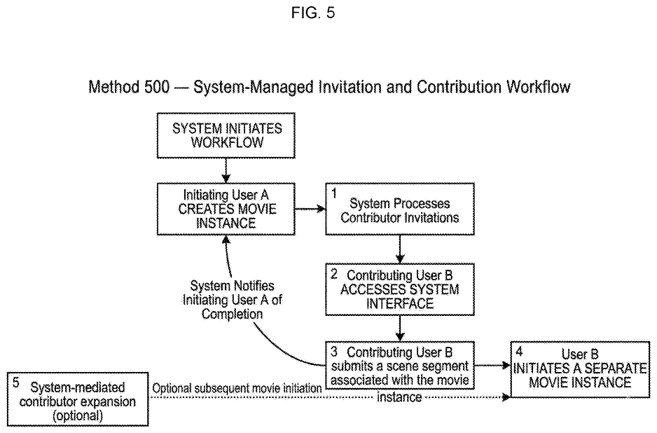

### Viral Growth Mechanics and Invitations (FIG. 5)

FIG. 5 illustrates an embodiment of a system-managed invitation and contribution workflow. In this embodiment, the system generates casting invitations or participation prompts for transmission to non-users or existing users via one or more communication channels. The system may associate invitation identifiers with resulting installation events, account creation events, role-claim events, or scene-submission events, thereby enabling measurement of recursive invitation-driven user acquisition and participation.

The system may track invitation metrics and conversion rates to measure viral effectiveness. Incentives such as tickets may be awarded for successful referrals. Social sharing of completed movies may further amplify visibility and user acquisition.

Collaborative features such as cloning, Fan Twists, Tag Twists, open-call casting, asynchronous participation, and public-feed publication may encourage users to invite others. Casting alerts may include deep links enabling prospective contributors to claim a role or open a specific production state immediately.

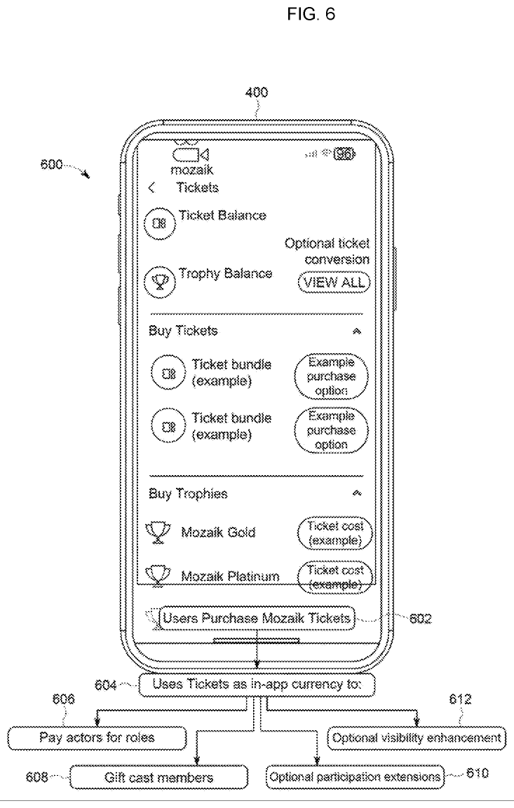

### In-App Currency and Monetization (FIG. 6)

FIG. 6 illustrates an operational sequence 600 involving tickets as a virtual in-app currency. Users may acquire tickets via purchase, rewards, challenge participation, gifts, or other participation incentives.

Tickets may be used to compensate actors, purchase digital gifts, extend deadlines or participation time, highlight a movie on the public feed, buy trophies, open optional role incentives, or access other platform features.

Gifts may be applied to entire casts, individual actors, or directors. In one embodiment, a first percentage of the gift value may be awarded to the director and a second percentage may be equally or proportionally divided among actors.

In certain embodiments, actors may receive tickets automatically upon scene acceptance, publication, or attainment of performance milestones.

The monetization subsystem may further support virtual items, optional participation boosts, award pages, purchase of extra challenge time, conversion to another virtual balance, and integration with linked bank or payout settings.

The digital-economy subsystem is not limited to any specific payment arrangement.

### System Architecture and Core Modules

A system architecture may include one or more servers configured to host a plurality of scene roles for a motion-picture script. The servers may manage production data, user accounts, role assignments, submission tracking, media processing, workflow transitions, automated assembly, moderation status, and publication state.

A casting interface may connect to the server and present available scene roles as open-call opportunities accessible to any computing device worldwide. Users may review requirements and claim open roles regardless of geographic location or professional background.

A role-claiming module may validate role-claim requests, assign roles, update availability status, and provide contributors with script lines, prompts, or performance instructions.

A scene-recording module may receive independently recorded video scenes uploaded asynchronously from remote devices. Contributors may record content at any location using mobile devices.

A contribution-management module may enforce performance rules, submission deadlines, script adherence checks, moderation gates, and role-specific permissions. Deadline monitoring may include reminders, expiration flags, role reopening, public-role conversion, fallback invitation workflows, or system-initiated completion logic when a contributor does not submit a required scene.

A scene-completion module may track submission status and determine when required scene files have been validated. Assembly may be blocked until required scenes are present in Core Mode, or may be conditionally triggered based on minimum-scene thresholds in tag-based modes.

In certain embodiments, the system may store each scene as a stateful asset associated with a workflow object representing the movie.

Upon completion of all required submissions, or upon satisfaction of another configured completion condition, the system may automatically publish the assembled movie to a public content feed.

Servers may operate within distributed computing infrastructures that store metadata, manage workflow state, monitor timestamps, and process media files into final output formats.

### Casting Interface and Contributor Workflow

The casting interface may render roles, script lines, performance notes, prompts, narrative context, and requirements for viewing on mobile or desktop devices. Users may claim available roles and receive instructions for recording assigned scenes.

No geographic limitation, professional credential, or organizational affiliation is required in certain embodiments. Users may contribute from anywhere in the world.

Contributors may record scenes from diverse locations using personal mobile devices. Contributors are not required to coordinate in real time.

The system may receive uploaded content from multiple countries or time zones. All content may be processed uniformly.

The scene-recording module may accept asynchronous uploads. Contributors may record and submit scenes at any time before their assigned deadlines.

Incoming files may be validated for format, duration, script adherence, content compliance, technical quality, assigned-scene identity, and other requirements.

### Deadline Enforcement (core Mode)

The contribution-management module may enforce deadlines for each assigned role, ensuring efficient production despite global dispersion of contributors.

If a contributor fails to submit in time, the system may reassign the role, re-open the role publicly, invite another user, notify a director, or otherwise maintain the production flow.

Submitted scenes may undergo technical validation and narrative checking. Files not meeting requirements may require resubmission.

### Completion Determination and Assembly Initiation

The scene-completion module tracks submission statuses and determines when all required scenes have been received or when another configured completion trigger has been satisfied.

When all system-defined completion conditions are satisfied, the system generates a completion signal that initiates the automated assembly engine. Completion conditions may include receipt and validation of all required scenes, execution of a wrap-and-publish command, attainment of a maximum allowable scene count, or expiration of a continuation deadline after at least a minimum scene threshold has been met, depending on the applicable embodiment.

In certain embodiments, completion is triggered exclusively by system-evaluated conditions rather than discretionary contributor editing actions. By requiring satisfaction of stored state conditions before assembly and publication can occur, the system implements state-gated media processing that prevents premature rendering, conflicting contributor control, and non-deterministic output generation.

In response to the completion signal, the system transitions the production to an assembly state and invokes the automated assembly engine to generate a rendered output file.

### Automated Assembly Engine

The assembly engine retrieves validated scenes and arranges them according to the applicable sequence order. In director-driven modes, the order may correspond to the script order defined by the director. In tag-based modes, the order may correspond to the order in which accepted scene submissions were contributed to the chain.

Stitching operations may include detecting scene boundaries, aligning audio frames, normalizing volume, applying title or credit cards, smoothing transitions, and rendering a composite output without human editing.

Director-selected or system-selected post-production effects, such as transitions, filters, background audio, sound effects, subtitles, overlays, or visual styles, may be applied automatically.

Color-grading operations may normalize lighting, contrast, and tonal consistency across scenes recorded with varied devices or in varied environments.

Rendered output files may be encoded into standard formats at one or multiple resolutions.

### Publication to Public Feed

Upon rendering, the system may automatically publish the completed movie to a global content feed. Metadata such as title, credits, timestamps, tags, genre, awards, ranking data, or monetization indicators may accompany the publication.

Contributors may receive notifications that the movie is publicly available. In some embodiments, viewers may comment, vote, gift, favorite, share, or otherwise engage with the published movie.

### System for Multi-Scene Digital Motion Picture Creation

The following paragraphs describe additional system-level characteristics and operational principles that apply broadly across embodiments of the invention.

The system may support recording scenes from any geographic location using personal mobile devices, enabling global asynchronous collaboration.

The casting interface may allow any user worldwide to join a production without belonging to a predetermined production crew.

The automated film-assembly engine may apply transitions, filters, background audio, color grading, title generation, subtitle generation, or other effects.

The contribution-management module may enforce submission deadlines.

The system may automatically publish final films to a public content feed.

The system may prevent assembly until all required remote contributors have submitted their required scenes in some modes, while in other modes the system may allow completion once minimum-scene conditions are met.

The system may maintain one or more workflow states associated with each production, including but not limited to draft, active, open-role, tagged-waiting, validating, pending, assembly, published, archived, or derivative-version states.

The system may store per-scene metadata including contributor identifiers, role identifiers, scene numbers, duration limits, deadline data, prompts, enhancement selections, and validation status.

The system may selectively permit or prohibit user actions depending on current state, mode, role, age classification, or permission status.

The system may generate public or private notifications, in-app inbox messages, push alerts, emails, or text messages corresponding to role assignment, deadline expiration, publication completion, voting milestones, or monetization events.

The system may support archiving, stopping autoplay, removing director credit, removing actor credit, or maintaining anonymous scene attribution in response to account-state changes, moderation outcomes, or other policy events.

The system may preserve published scene contributions even when a user account is deleted, while anonymizing associated identity information.

The system may further support search and filtering by popularity, movie title, stage name, hashtags, award status, favorite status, genre, personalized ranking, or challenge participation status.

### General Interpretive & Legal Framework

The disclosed embodiments improve the functioning of computing systems by reducing manual processing states, eliminating user-directed editing dependencies, and enabling deterministic execution of distributed media assembly workflows through system-enforced state transitions and automated invocation of processing modules.

The disclosed system provides technical improvements over conventional collaborative video platforms by: (i) eliminating race conditions that occur when multiple users attempt to modify shared timelines or sequencing logic; (ii) reducing server and client processing overhead through state-gated assembly that prevents premature or conflicting rendering operations; (iii) enabling participation by resource-constrained mobile devices without requiring such devices to maintain a complete project timeline or global production state; and (iv) ensuring deterministic completion and bounded execution through automated deadline enforcement and system-initiated termination logic.

The foregoing description is illustrative rather than limiting. Features described with respect to any embodiment may be used in others unless explicitly incompatible. The scope of the invention is defined solely by the appended claims and their legal equivalents.

Although the invention has been described with reference to specific embodiments, those skilled in the art will recognize that various modifications may be made without departing from its spirit or scope.

Any disclosed subject matter not expressly claimed is not dedicated to the public. The applicant reserves the right to pursue additional claims in future filings.

While certain narrow claims may be presented, the applicant intends that broader claims may be pursued in applications that claim priority to this specification.

This application covers any variations, adaptations, implementations, or uses of the invention based on the principles described herein.

FIG. 7B further illustrates a Movie-Tag sequential production workflow in which the system receives a sequential scene submission from a contributing user, prompts that contributing user to select a continuation option for a subsequent scene, enforces a submission deadline for the tagged or selected next contributor, receives either a subsequent scene submission or detects expiration of the submission deadline, and conditionally either transitions the project to a pending state or automatically assembles and publishes the movie once minimum scene-completion conditions are satisfied.

### MOVIE-TAG MODE (CIP NEW MATTER)

### MT-001

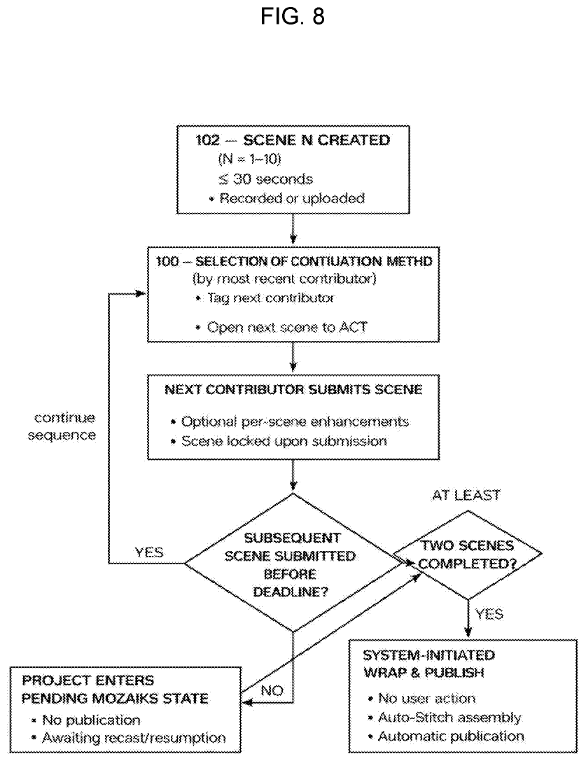

FIG. 8 illustrates an example operational flow.

### MT-002

In Movie-Tag Mode, a first user records or uploads an initial video scene. The scene may be captured using the system's in-app camera or selected from external video files. Scene duration may be limited, for example, to thirty seconds.

### MT-003

After submission of an initial or subsequent scene, the system presents the most recent contributing user with a continuation-selection interface corresponding to block 100 of FIG. 8.

### MT-004

Through block 100, the contributor may tag or designate exactly one next contributor, or may open the next scene to the public Act page or another open-call participation pool. In some embodiments, if at least a minimum number of scenes has already been completed, the system may also permit a wrap-and-publish command.

### MT-005

The continuation-selection interface may be limited to the immediately most recent contributor so that only the user associated with the latest accepted scene may determine how the next scene opportunity is offered. This preserves sequential control and prevents unauthorized branching.

### MT-006

The system may associate each scene with a sequence index N, where N may range from 1 to a maximum permitted scene count such as 10. Block 102 of FIG. 8 represents creation of Scene N, which may be recorded or uploaded and may be subject to a maximum duration.

MT-007

Before final submission, contributors may re-record their assigned scene any number of times and may optionally apply per-scene enhancements such as background music, color filters, background image selection, title overlays, subtitle selections, audio balancing, and video trimming.

### MT-008

Once a scene is submitted and accepted by the system, the scene becomes locked and cannot be replaced or edited by the contributor. The system may preserve the contributor's selected per-scene enhancements for later assembly.

### MT-009

If a subsequent contributor submits a next scene before expiration of an applicable deadline, the system may continue the sequence according to the left-side continuation loop shown in FIG. 8, allowing the newly accepted contributor to make the next continuation selection.

### MT-010

If no subsequent scene is submitted before the applicable deadline, the system evaluates whether at least a minimum number of scenes has been completed, as shown by the decision path in FIG. 8.

### MT-011

If the minimum number of completed scenes has been met, the system automatically executes a system-initiated wrap-and-publish operation without requiring further user action. In such case, the system invokes the automated assembly engine, assembles accepted scenes, and publishes the resulting movie.

### MT-012

If the minimum number of completed scenes has not been met when no subsequent scene is submitted before deadline expiration, the system transitions the project into a pending state.

### MT-013

A pending-state project may remain unpublished and may await recast, resumed continuation, director intervention, or another reactivation event.

### MT-014

Movie-Tag Mode may require at least two completed scenes for publication.

### MT-015

In some embodiments, Movie-Tag Mode may limit the chain to a maximum of ten sequential scenes. If the maximum scene count is reached, the system may automatically force a wrap-and-publish path or may present only a finalization option to the last contributor.

### MT-016

The system may automatically generate title metadata, hashtag metadata, genre metadata, or other descriptive metadata for Movie-Tag movies based on one or more of script content, contributor inputs, scene analysis, image recognition, audio analysis, artificial-intelligence interpretation, or platform taxonomies.

### MT-017

All Movie-Tag films may be published as public content in some embodiments and may not be designated as private by contributors.

### MT-018

Only contributors who participated in the chain may be permitted to create a Tag Twist, Director's Cut, or other derivative version of a completed Movie-Tag film.

### MT-019

A Tag Twist may function similarly to a Director's Cut or derivative extension but may be limited, for example, to one prequel scene and/or one sequel scene.

### MT-020

Movie-Tag Mode may be fully compatible with the platform's in-app currency ecosystem, enabling directors or contributors to offer tickets or other virtual incentives to encourage role acceptance or timely scene submission.

### MT-021

In some embodiments, when a tagged contributor declines participation or fails to submit a required scene before expiration of the associated deadline, the system may optionally initiate a fallback process if such process was selected for the current scene opportunity.

### MT-022

The fallback process may include iteratively inviting users from a predefined list, such as a ‘fans of’ list, follower list, social graph list, preferred-contributor list, or other ordered contributor pool associated with the most recent contributor, director, or project.

### MT-023

The system may transmit fallback invitations one at a time or according to another controlled sequence until a contributor submits a valid scene or the candidate list is exhausted.

### MT-024

If no contributor submits a subsequent scene after tagged invitation, optional fallback processing, and any open public participation opportunity are exhausted, the system evaluates the current state of the Movie-Tag project. If at least two scenes have been completed, the system automatically completes assembly and publication. If fewer than two scenes have been completed, the project remains pending.

### MT-025.

The automatic completion and publication behavior of Movie-Tag Mode is executed by the system independently of user intent once predefined termination conditions are satisfied. This system-initiated completion prevents indefinite chain propagation, enforces bounded execution, and ensures deterministic finalization of the motion picture.

### MT-026

The assembly engine in Movie-Tag Mode joins the sequentially accepted scenes in contribution order while preserving each contributor's approved per-scene enhancements.

### MT-027

Upon completion, the final Movie-Tag film may be rendered, stored, and automatically published to the public feed. Contributors may receive notifications when rendering and publication are complete.

### MT-028

All Movie-Tag sequences may be stored as structured chain objects in a database. Each chain object may include contributor identifiers, scene-level metadata, prompt lineage data, per-scene enhancements, timestamps, deadlines, public-or-private opportunity indicators, system-generated narrative context, and status flags.

### MT-029

Dynamic prompt generation may use script analysis, prior-scene text extraction, performance tags, natural-language processing, user-provided descriptions, or artificial-intelligence inference to maintain narrative continuity across scenes in the chain.

### MT-030

Movie-Tag Mode may coexist with Core Mozaik modes including Direct, Act, Compete, and Engage without altering or interfering with their workflows, data structures, or system requirements. Additional embodiments may include alternative prompt-generation strategies, expanded contributor limits, additional editing tools, alternative completion thresholds, or enhanced scene-transition logic.

FIG. 8 illustrates a movie-tag mode flowchart and corresponding workflow.

FIG. 8 is a flowchart illustrating an embodiment of a tag-based sequential filmmaking workflow (‘Movie-Tag Mode’). At block 102, a user creates Scene N using the system application. Scene N may be recorded or uploaded and may have a maximum duration, such as thirty seconds. After Scene N is accepted, the system presents the most recent contributor with a continuation-selection interface at block 100. Through block 100, the contributor may tag a next contributor or open the next scene to a public Act participation opportunity. If a subsequent scene is submitted before deadline expiration, the system continues the sequence. If no subsequent scene is submitted before deadline expiration, the system determines whether at least a minimum number of scenes has been completed. If the minimum has been met, the system executes a system-initiated wrap-and-publish operation, invokes auto-stitch assembly, and automatically publishes the resulting movie. If the minimum has not been met, the project enters a pending state awaiting recast or resumption.

1. A system for producing a multi-scene digital motion picture, comprising:
at least one processing device comprising a processor and non-transitory memory storing executable instructions that, when executed, cause the processing device to:
receive director-defined production metadata specifying:
(i) a plurality of scene roles,
(ii) a scene sequence structure,
(iii) one or more per-scene duration constraints,
(iv) contributor assignment rules,
(v) one or more submission deadlines, and
(vi) one or more automated post-production templates;
publish the plurality of scene roles to a distributed network environment such that multiple geographically distributed contributors may asynchronously record and submit independently captured video scenes using personal mobile devices;
associate each submitted video scene with a corresponding workflow object and assign one or more workflow states including at least:
capture,
validation,
assembly,
publication,
or archived states;
validate each submitted video scene according to one or more predefined validation conditions including at least:
duration compliance,
submission timing compliance,
technical-format compliance,
moderation compliance,
or assigned-scene identity compliance;
maintain a system-controlled production workflow in which progression between workflow states is controlled exclusively by system-enforced execution rules rather than contributor-directed editing operations;
prevent assembly of the multi-scene digital motion picture until one or more predefined completion conditions are satisfied;
upon satisfaction of the predefined completion conditions, automatically generate a completion signal that transitions the production workflow into an assembly state and invokes an assembly engine configured to:
retrieve validated video scenes;
assemble the validated video scenes according to the scene sequence structure;
apply one or more automated post-production operations; and
generate a rendered motion-picture output file;
prevent contributor-level modification of sequencing, transitions, assembly ordering, or rendering operations after submission of the independently captured video scenes;
wherein the system produces a deterministic assembled motion-picture output through state-gated execution and automated invocation of assembly operations without requiring manual post-production editing.

2. The system of claim 1, wherein the processing device further executes a state-transition controller configured to enforce exclusive state progression such that scene validation, assembly invocation, and publication occur only upon satisfaction of system-defined state conditions, thereby preventing race conditions associated with collaborative editing.

3. The system of claim 1, wherein the processing device is configured to monitor submission timestamps and automatically prevent late scene submissions from inclusion in the assembled motion picture.

4. The system of claim 1, wherein contributors are prohibited from editing, rearranging, trimming, or sequencing scenes after submission, and wherein all post-production operations are executed automatically by the assembly engine using director-defined metadata.

5. The system of claim 1, wherein the assembly engine automatically applies at least one of transitions, background audio, visual filters, or color grading uniformly across all scenes without manual editing.

6. A system for producing a multi-scene digital motion picture using a sequential tag-based
workflow, comprising:
at least one processing device comprising a processor and non-transitory memory storing executable instructions that, when executed, cause the processing device to:
receive a first video scene submission associated with a first contributor;
associate the first video scene submission with a sequential scene index within a structured movie-chain object maintained by the system;
present, after acceptance of the first video scene submission, a continuation-selection interface exclusively to the contributor associated with a most recently accepted scene submission;
permit the contributor associated with the most recently accepted scene submission to selectively:
(i) designate exactly one subsequent contributor for a next scene submission,
(ii) open the next scene submission to a public participation pool, or
(iii) initiate a wrap-and-publish operation when a minimum completed-scene threshold has been satisfied;
enforce a submission deadline associated with the next scene submission using stored deadline metadata;
detect expiration of the submission deadline without receipt of a valid next scene submission;
in response to expiration of the submission deadline, automatically evaluate one or more system-defined completion conditions including at least:
(i) a completed-scene threshold condition,
(ii) a maximum-scene threshold condition, and
(iii) a continuation-exhaustion condition;
upon satisfaction of at least one of the system-defined completion conditions, automatically transition the movie-chain object to an assembly state and invoke an assembly engine configured to:
assemble accepted scene submissions in contribution order;
apply automated post-production operations;
generate a rendered motion-picture output file; and
publish the rendered motion-picture output file to a public content feed without requiring further user-directed editing actions;
when the completed-scene threshold condition is not satisfied upon expiration of the submission deadline, automatically transition the movie-chain object into a pending workflow state awaiting subsequent continuation activity;
wherein the system prevents contributor-level branching, concurrent scene-authoring authority, discretionary sequence modification, or manual assembly control during execution of the sequential tag-based workflow.

7. The system of claim 6, wherein the system automatically executes the wrap-and-publish operation when at least two accepted scene submissions exist and no valid subsequent scene submission is received before expiration of the submission deadline.

8. The system of claim 6, wherein the system limits the sequential tag-based workflow to a maximum permitted scene count and automatically restricts further continuation selections upon reaching the maximum permitted scene count.

9. The system of claim 8, wherein the maximum permitted scene count is ten scenes.

10. The system of claim 6, wherein the pending workflow state is maintained when fewer than two accepted scene submissions exist upon expiration of the submission deadline.

11. The system of claim 6, wherein the processing device further executes a fallback contribution process configured to:
identify an ordered contributor pool associated with at least one of:
(i) a most recent contributor,
(ii) a director,
(iii) a follower relationship,
(iv) a fan relationship, or
(v) a preferred-contributor list; and
iteratively transmit subsequent scene invitations until either:
(a) a valid scene submission is received, or
(b) the ordered contributor pool is exhausted.

12. The system of claim 11, wherein the system automatically evaluates the completed-scene threshold condition after exhaustion of the ordered contributor pool.

13. The system of claim 6, wherein each accepted scene submission becomes locked after acceptance such that the associated contributor cannot modify, replace, or resequence the accepted scene submission prior to assembly.

14. The system of claim 6, wherein contributors may apply one or more per-scene enhancements prior to submission including at least one of:
background music,
visual filters,
background images,
title overlays,
subtitle selections,
audio balancing,
or video trimming.

15. The system of claim 14, wherein the assembly engine preserves the per-scene enhancements during assembly of the rendered motion-picture output file.

16. The system of claim 6, wherein the processing device automatically generates metadata for the rendered motion-picture output file including at least one of:
title metadata,
hashtag metadata,
or genre metadata.

17. The system of claim 6, wherein the processing device is configured to publish rendered motion-picture output files generated by the sequential tag-based workflow as public content.

18. The system of claim 6, wherein only contributors associated with accepted scene submissions within the sequential tag-based workflow are authorized to create derivative versions of the rendered motion-picture output file.

19. The system of claim 18, wherein the Tag Twists are limited to addition of at most one prequel scene and/or one sequel scene.

20. The system of claim 6, further comprising a virtual-currency subsystem configured to provide digital incentives for accepting tagged scene invitations or submitting scenes before expiration of associated deadlines.
